(19) United States
(12) Patent Application Publication
(10) Pub. No.: US 2011/0258211 A1
(43) Pub. Date: Oct. 20, 2011

(54) SYSTEM AND METHOD FOR SYNCHRONOUS MATCHING OF MEDIA SAMPLES WITH BROADCAST MEDIA STREAMS

(76) Inventors: OFER KALISKY, Raanana (IL); Elon Gecht, Ramat Hasharon (IL)

(21) Appl. No.: 13/086,409

(22) Filed: Apr. 14, 2011

Related U.S. Application Data
(60) Provisional application No. 61/325,322, filed on Apr. 18, 2010.
(60) Provisional application No. 61/325,323, filed on Apr. 18, 2010.

(51) Int. Cl. G06F 17/30

(52) U.S. Cl. 707/758; 707/E17.005

(57) ABSTRACT

Systems and methods are disclosed for matching media clips. A media matching system is operable to deliver a content stream to a media receiving device. The content stream may be synchronized to a media stream received by a primary media receiving device. The output signal of the primary media receiving device is sampled and clip data sent to a data matching mechanism operable to match the sampled clip data to media clips extracted from media streams. The systems and methods provide real time matching of clip data and enable synchronization between delivered content and broadcast media streams.

### CROSS-REFERENCE TO RELATED APPLICATIONS

This application claims priority benefit from U.S. Provisional Patent Application No. 61/325,322, filed Apr. 18, 2010, and U.S. Provisional Patent Application No. 61/325,323, filed Apr. 18, 2010, which are incorporated herein by reference in their entirety.

### FIELD OF THE INVENTION

The systems and methods disclosed herein relate to the sampling and matching of clips of multimedia data. In particular systems and methods are disclosed for synchronizing multiple data streams between multiple devices.

### BACKGROUND OF THE INVENTION

Multimedia content, such as video, audio, images, text, applications, games and the like, may be received by a variety of end user devices. For example, a video data stream, such as a television show for example, may be distributed by multiple channels which may be received by multiple devices, such as television sets, computers, smartphones, games consoles, tablet devices and so on.

Users having multiple devices may require receiving related multimedia content on a plurality of their devices. In order to do so, each device often needs to receive separate data streams via different channels. Therefore a user is typically required to access each data stream separately from each device. This is inconvenient, time consuming and undesirable. Furthermore, the problem is particularly acute where the identity of the data stream is unknown, such as when a user, flicking through various television channels, may chance upon a show without knowing the identity of either the show or the channel.

Even where multiple channels are accessed simultaneously, due to buffering requirements and such like, the channels do not necessarily stream data at exactly the same rates leading to synchronization problems across different platforms.

There is a need therefore for user friendly methods and systems for identifying multimedia data streams and synchronizing multiple data channels between devices. The embodiments disclosed herein address this need.

### SUMMARY OF THE INVENTION

Embodiments are disclosed herein of a media matching system operable to deliver at least one content stream to at least one media receiving device, the content stream being at least partly synchronized to at least one media stream received by a primary media receiving device. The system comprises at least one of a data matching mechanism and/or a media sampler.

The data matching mechanism may comprise at least one database for storing a plurality of candidate media clip fingerprints pertaining to the at least one media stream; at least one comparator, operable to match at least one candidate media clip fingerprint to a fingerprint of clip data pertaining to a sampled clip of an output signal from the primary media receiving device; and at least one content selector, operable to send the content stream to at least one address.

The media sampler may be operable to collect a sample of the output signal from the primary media receiving device; and send clip data pertaining to the sample of the output signal to the comparator.

The data matching mechanism may further comprise a data extractor in communication with the database. The data extractor may be operable to receive media data from at least one media stream; to process the media stream to generate the candidate media clip fingerprints; and to save the candidate media clip fingerprints in the database.

The media sampler may be associated with a secondary media receiving device operable to receive the content stream. The secondary media receiving device is selected from at least one of a group consisting of: mobile telephones, tablet computers, games consoles, computers, television sets and combinations thereof.

According to another aspect, a method is taught for delivering at least one content stream to at least one media receiving device, the content stream being at least partly synchronized to at least one media stream received by a primary media receiving device. The method may comprise at least the following steps:
a data matching mechanism receiving at least one the media stream;
the data matching mechanism processing at least one media stream to generate a plurality of candidate media clip fingerprints;
saving the candidate media clip fingerprints to a database;
receiving clip data pertaining to a media signal;
obtaining a fingerprint of the media signal;
a comparator comparing the fingerprint of the media signal with at least one candidate media clip fingerprint;
matching the media signal to at least one candidate media clip; and
sending the content to at least one address.

Optionally, the method may further comprise a sampler performing a number of steps, such as collecting an output media signal from the primary media receiving device; processing the media signal to generate the clip data; and sending the clip data to the data matching mechanism.

Where required, the step of processing the media signal comprises fingerprinting the media signal, and indexing the media signal.

Optionally, the step of obtaining a fingerprint comprises segmenting a media sample into a plurality of segments. The method may continue with generating a characteristic vector for each segment of the media sample by performing a fourier transform on each segment of the media sample, dividing the transform into a plurality of frequency bands and arraying the signal levels for all frequency bands. The method may continue with combining the characteristic vectors of each segment of the media sample.

Where required, the method may further comprise a step of indexing the fingerprints. Where the fingerprints comprise an array of signal levels, the indexing may comprise: generating a profile of the fingerprint; selecting a threshold signal level, and counting the number of times the profile crosses the threshold.

In some embodiments, the method step of comparing the fingerprint of the media signal with at least one candidate media clip fingerprints may comprise calculating a correlation index Δ between a first series of N values sₙ, pertaining to the fingerprint of the media signal, and a second series of N values σₙ, pertaining to the candidate media clip fingerprints. The correlation index may be calculated by a formula:

$$Δ = {\sum }_{1}^{N} \{ {[ sgn ( {s}_{( n + 1 )} - {s}_{n} ) - sgn ( {σ}_{( n + 1 )} - {σ}_{n} ) ]}^{2} \}$$

Accordingly, the method may further include matching the media signal to at least one the candidate media clip fingerprint by: selecting at least one candidate media clip fingerprint; calculating a correlation index Δ for each candidate media clip; comparing the correlation index Δ to a threshold value Δₜₕ for each candidate media clip; and selecting a candidate media clip fingerprint having a correlation index Δ below the threshold level Δₜₕ.

Additionally or alternatively, the method may further include matching the media signal to at least one the candidate media clip fingerprint by: comparing the media signal to all of at least a subset of candidate signals; and selecting the candidate media clip fingerprint with the lowest correlation index Δ.

According to some embodiments, the candidate media clip is selected from a subset of candidate media clip fingerprints stored in the database. Optionally the candidate media clip is selected from a subset containing candidate media clips extracted from the media stream in a given time period. Additionally or alternatively, the subset comprises candidate media clip fingerprints having an index value close to that of the media signal fingerprint.

In still another aspect, another method is taught for delivering at least one content stream to at least one media receiving device, the content stream being at least partly synchronized to at least one media stream received by a primary media receiving device. The method comprises the steps:
obtaining a sampling device;
the sampling device collecting an output media signal from the primary media receiving device;
the sampling device processing the media signal to generate clip data;
sending the clip data to a comparator operable to compare the clip data to media data extracted from the media stream and stored in a database; and
receiving the content stream from a content selector, the selector operable to select content at least partially synchronized to the media stream.

Optionally, the step of processing the media signal to generate clip data comprises fingerprinting the media signal. Such fingerprinting of the media signal may comprise segmenting a media sample into a plurality of segments; generating a characteristic vector for each segment of the media sample and combining the characteristic vectors of each segment of the media sample. Optionally, the characteristic vector may be generated by performing a fourier transform on each segment of the media sample; dividing the transform into a plurality of frequency bands; and arraying the signal levels for all frequency bands;

### BRIEF DESCRIPTION OF THE DRAWINGS

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the several selected embodiments may be put into practice. In the accompanying drawings:

FIG. 1 is a schematic block diagram representing selected elements of a general embodiment of a multimedia synchronization system;

FIG. 2 is a schematic representation of a particular example of a synchronization system used to synchronize data streams to a television and a telephone;

FIGS. 3A and 3B show a flowchart representing the main steps of a method for matching a content stream to a multimedia stream;

FIG. 4A is a flowchart representing the steps of a method for fingerprinting a clip of sampled media;

FIG. 4B graphically represents sampled media being segmented and processed according to a fingerprinting method;

FIG. 4C graphically represents a fingerprint of the sampled media;

FIG. 5 is a flowchart representing the steps of a method for indexing a clip of media data;

FIG. 6 is a flowchart representing the steps of a method for populating a database of media samples;

FIG. 7A schematically represents two fingerprinted media data samples being compared; and

FIG. 7B is a flowchart representing the steps of a method for matching a fingerprint of a sampled media clip to a fingerprint of a media clip selected from a database.

### DETAILED DESCRIPTION OF THE INVENTION

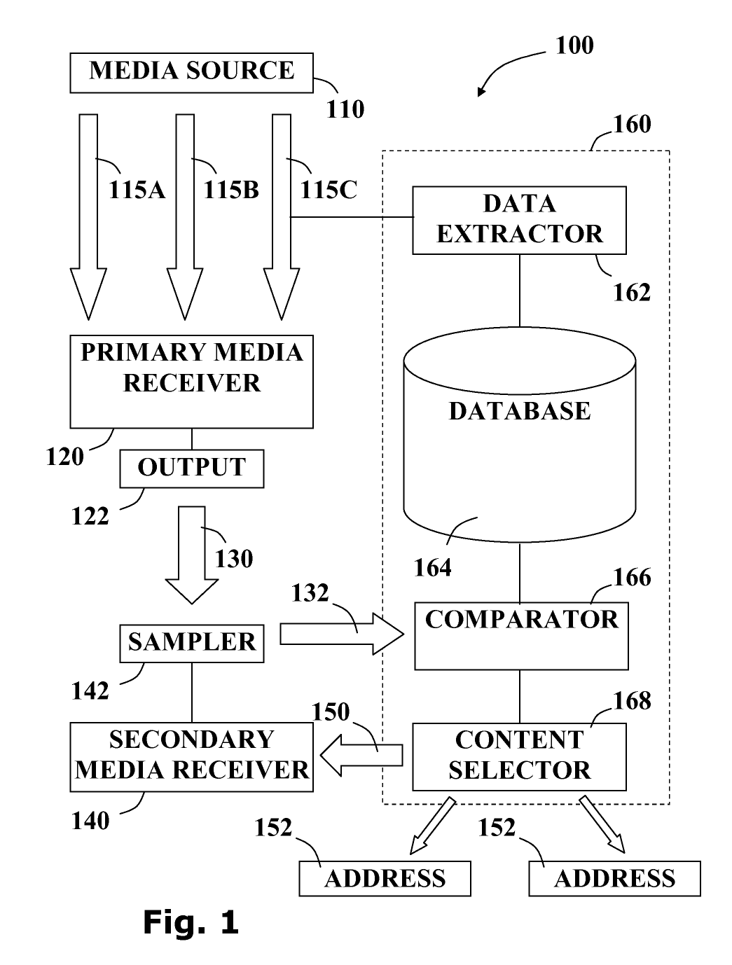

Reference is now made to the block diagram of FIG. 1 representing selected elements of a general embodiment of a multimedia synchronization system 100. The system 100 includes a primary media reception device 120, a sampler 142, a secondary media reception device 140 and a data matching mechanism 160.

The data matching mechanism 160 is operable to match a content stream 150 received by the secondary media reception device 140 to a media stream 115A being received by the primary reception device 120. The data matching mechanism 160 includes a data extractor 162, a database 164, a comparator 166 and a content selector 168.

The primary media reception device 120, such as a television, radio, internet radio, computer, communication device, games consul or the like, is operable to receive at least one of a set of media streams 115A-C from at least one media broadcaster 110. The primary media reception device 120 is further operable to display or transmit the received media streams via an output 122, such as a visual display unit, loudspeaker, touch display or the like.

The secondary media reception device 140, for example another television, radio, internet radio, computer, communication device such as telephone or tablet computer, games consul or the like, may be in communication with the data matching mechanism 160 and may be operable to receive a content stream 150 from the content selector 168.

The sampler 142 is operable to detect an output signal 130 from the primary media reception device 140. It is noted that optionally, the sampler 142 may be integral to the secondary media reception device 140. Accordingly, the secondary media reception 130 may be further operable to sample the output signal 130 and to transmit clip data 132 pertaining to the sampled media clip to the comparator 166. Alternatively, a separate sampler unit 142 may transmit clip data 132 independently.

The clip data 132 may include a fingerprint of sampled audio data possibly with a date and time stamp identifying the time at which it was sampled. Other forms of clip data 132 may alternatively or additionally be transferred, such as an unprocessed data stream of the sample, a profile series such as described hereinbelow and so on.

The data matching mechanism 160 is operable to receive sampled clip data 132 from the secondary media reception device 140 and to match the sampled clip data 132 to a location in at least one of the media streams 115A-C. Accordingly, the content stream 150 transmitted to the secondary media reception device 140 may be synchronised with the particular media stream 115A being received by the primary reception device 120.

It is a particular feature of the data matching mechanism 160 that it may comprise a data extractor 162 configured to receive and process data from at least one media stream 115A as it is broadcast in real time. The data extractor 162 is operable to store and, where required, index the processed data in a database 164 in a readily accessible format. The database 164 may store fingerprints of the media and/or raw media data. Where appropriate, a dedicated fingerprint database and a dedicated media database may be provided, alternatively, a common database may store both fingerprints and raw data.

The comparator 166 is operable to receive clip data 132 from at least one secondary media reception device 140 and to compare the received clip data 132 with entries in the database 164. By matching the received clip data 132 with a data entry of the database 164, the comparator 166 is able to identify the media stream 115, and the location within that media stream 115, from which the received clip data 132 was sampled.

Having identified the clip data 132 sent to the data matching mechanism 160, the content selector 168 selects a content stream 150 to transmit to the secondary media reception device 140. The content stream 150 may be selected according to a variety of parameters including but not limited to the identity of the clip, the identity of the media stream, perhaps in response to user preferences.

The data transferred in the content stream 150 may include a variety of content types. For example, the content stream 150 may transfer metadata relating to the primary media stream 115A, for example, additional information about the content displayed by the primary reception device 120. Where the content stream 150 is synchronized with the primary media stream 115, this metadata may be related directly to the content displayed by the primary reception device 120 in real time. Thus, for example, a viewer of a television program may access information regarding the actors or presenters, the identity of the music being played, background information related to the plot and so on.

In a particular example, the content stream 150 may provide subtitles synchronized to a television show. Alternatively, the content stream 150 may provide alternative audio track synchronized to the television show. Such a set up may allow different users to access audio dubbed into a variety of languages for example. It will be appreciated that in order to maintain synchronization of the primary media stream 115A and the content stream 150, multiple samples 130 may be obtained and processed in an ongoing manner.

Alternatively or additionally, the content stream 150 may be directed towards displaying a user interface for providing feedback for live competitions and the like. Such a user interface may provide a two way communications channel allowing a user to interact with a live television show. It is particularly noted that because the content stream 150 may be synchronized with the output of the primary media reception device 120, such a user interface may relate directly to the output in real time.

In other embodiments, the content stream 150 may provide a mirror stream similar or identical to the primary media stream 115A. Where required, the mirror stream may be synchronized therewith. This may be particularly useful for example for a user who is watching, say, a sports match, TV show or the like on a television set and needs to move into another room. The user may use the multimedia synchronization system 100 to synchronize a content flow to a portable device, such as a mobile telephone, tablet, games console or the like, which may be carried by the user so as to continue watching the original stream uninterrupted.

In still further embodiments, the content selector 168 may be additionally or alternatively configured to send selected content to additional addresses 152. Accordingly, a user may be able to use the system 100 to communicate with other users, for example contacts across a social network for example. Viewers of a television show may thereby be able to send clips, trailers or the like to friends and contacts in real time, chat about the show and if required synchronize a media stream with contacts.

Another feature of the system 100 is that, upon instruction from a user, sampled media clips, such as video clips, audio clips, games, applications and the like may be uploaded to internet addresses. For example a video clip may be sampled by a user and sent to a video sharing website such as YouTube, Myspace, Tudou, Flickr, Metacafe and the like. Where required, the clip may be sent from the data matching mechanism 160 directly. Alternatively, a user may be able to edit the clip before it is uploaded, downloaded, shared or otherwise distributed.

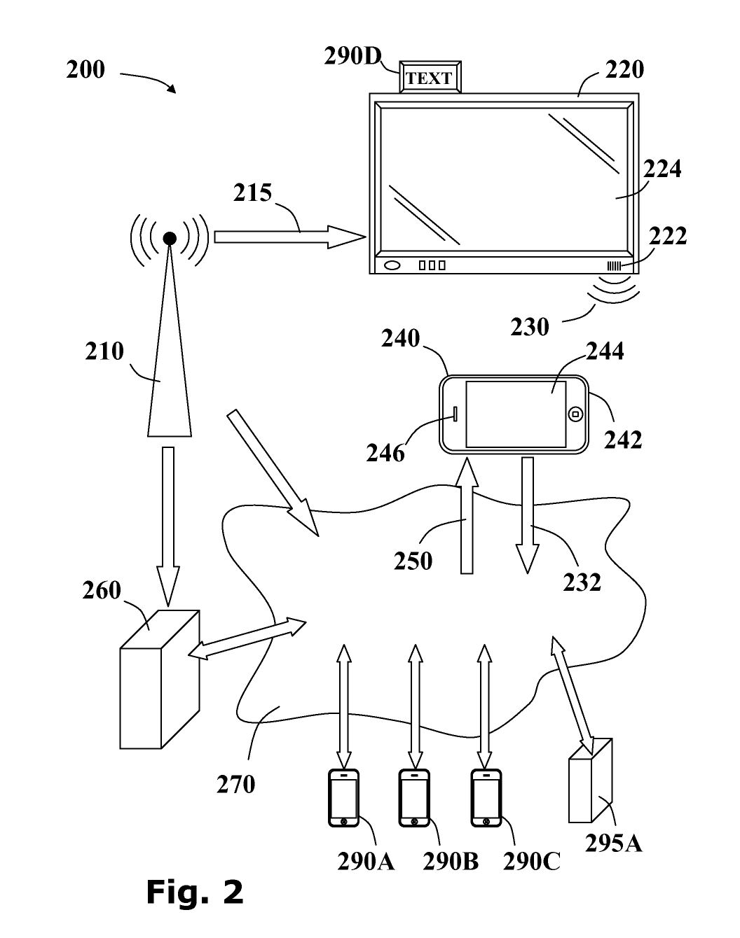

Reference is now made to FIG. 2 showing a schematic representation of a particular example of a synchronization system 200. In the particular example, a multimedia synchronization system 200 is shown synchronizing a content stream 250 received by a mobile telephone 240 to a multimedia data stream 215, received by a television set 220 from a broadcasting station 210.

The television set 220 is configured to receive at least one multimedia data stream 215. The data may be received via a cable, a radio wave antenna, a satellite dish, internet connection or other reception device as known in the art. The television set 220 has a screen 224, upon which visual images decoded from the data stream 215 may be displayed, and a loudspeaker 222, which may broadcast an audio output 230 accompanying the visual images displayed upon the screen 224.

The mobile telephone 240, possibly but not exclusively a smart phone such as Apple's iPhone®, HTC's Dream®, Nokia's N8® or any other suitable unit, includes a screen 244 and a loudspeaker 246 for outputting visual images and audio respectively. It is noted that the telephone 240 further includes a microphone 242 for receiving audio signals. In this example, the microphone 242 of the mobile telephone 240 serves as a sampler 142 (FIG. 1) for the multimedia synchronization system 100 (FIG. 1).

The mobile telephone 240 has an internal processor (not shown) operable to run a software application enabling the microphone 242 to sample the audio output 230 of the television set 220. The mobile telephone 240 may have a transmission circuit and antenna via which it may connect to a cellular network and connect to the internet 270. The processor of the mobile telephone 240 converts the sampled audio clip into clip data 232 which may unambiguously identify the clip sampled. Accordingly, the software application may fingerprint the sampled clip, a method for which is described hereinbelow, and the fingerprint may be sent as clip data 232, perhaps with an associated time stamp. Alternatively, the sampled clip may be transmitted as raw data.

The clip data 232 may be in a form suitable to be quickly and efficiently communicated via the internet 270 to a data matching server 260. It will be appreciated that other communication channels such as a mobile network may be used in addition to or in place of the internet connection, to transfer the clip data to the data matching server 260.

The data matching server 260 is operable to receive clip data 232 and any other instructions from the mobile telephone 240. The data matching server 260 is also operable to receive the multimedia data stream 215 from the broadcasting station 210 either directly, via the internet or through some other communications channel. The data matching server 260 further indexes and stores searchable data pertaining to the multimedia data stream 215 in real time, a method for which is described hereinbelow, such that the clip data 232 identifying the sampled clip can be rapidly matched to the data stream 215 and the time in that data stream 215 from which it was sampled.

Upon receiving clip data 232 and any other instructions from the mobile telephone 240, the data matching server 260 is operable to send content 250 to multiple units 240, 290A-D, 295. For example, the data matching server may send to the mobile telephone 240, metadata as well as a synchronized dubbed soundtrack to the television show. Simultaneously, according to instructions sent by the mobile telephone 240, synchronized subtitles may be sent to an internet connected display device, such as an electronic picture frame 290D or the like, placed upon the television set 240.

The data matching server 260 may further send content 250 via other reception units 290B to other users such as social network contacts. It is further noted that content 250 may be uploaded directly to online servers 295 directly, for example by uploading a clip directly to a video sharing website or social network for example.

### Media Synchronization Method

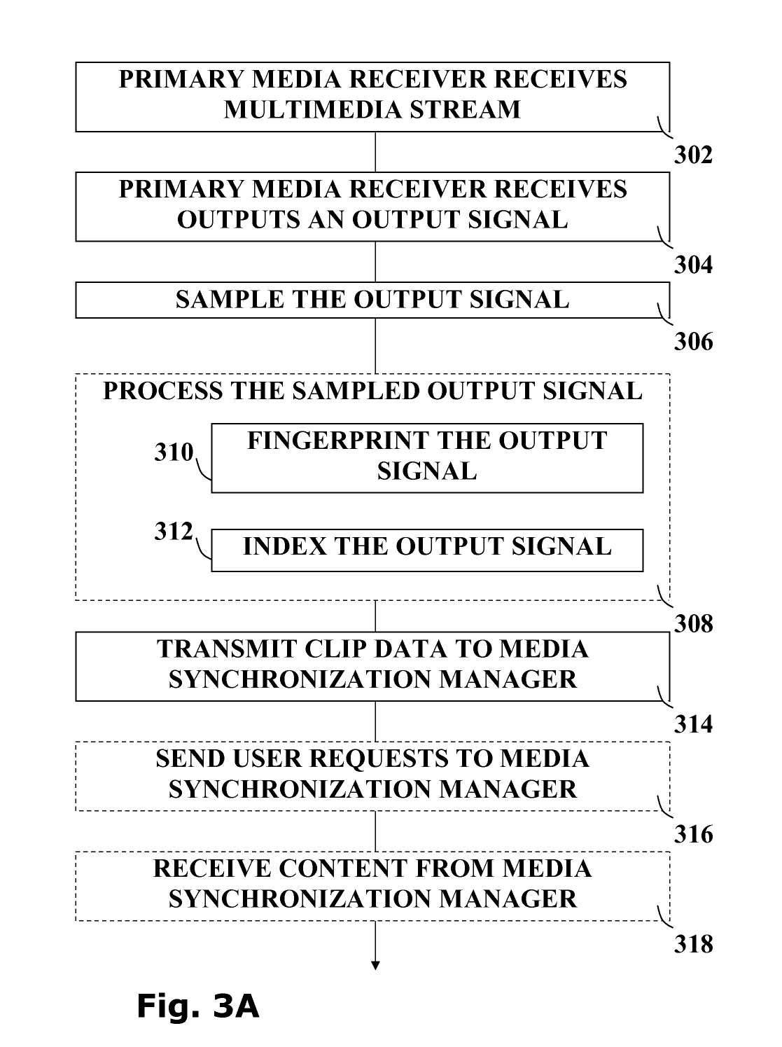

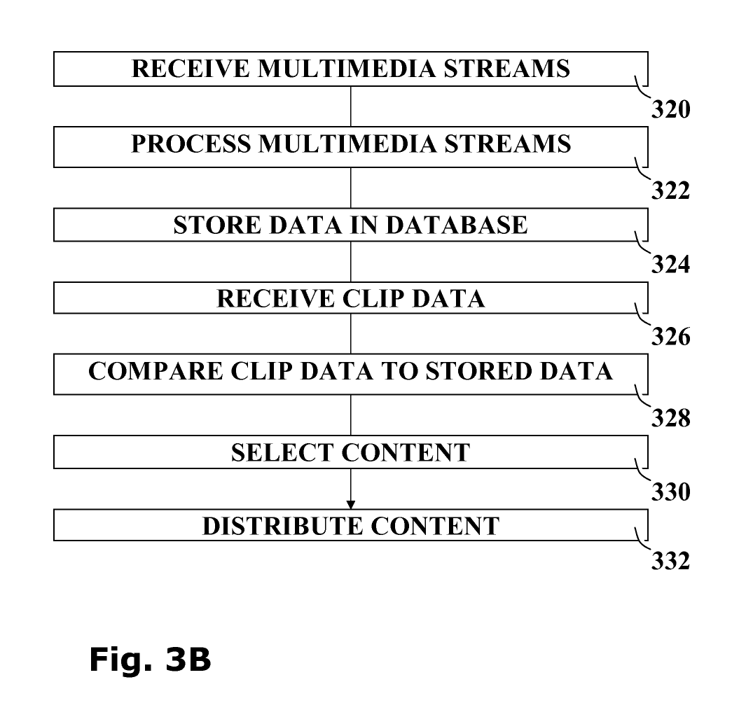

Reference is now made to the flowchart of FIGS. 3A and 3B representing the main steps of a method for matching a content stream from a media synchronization manager to a multimedia stream received by a primary media reception device. Although FIGS. 3A and 3B represent a single flowchart, for the sake of clarity the flowchart has been divided with FIG. 3A representing the steps generally performed at the user side and FIG. 3B representing steps generally performed at the media synchronization manager side. It will be appreciated that this division is for convenience and ease of explanation only, it is not crucial to the overall method where any particular step is executed and in distributed systems, steps may be performed in multiple locations.

With particular reference to FIG. 3A, the primary media reception device, such as a television or the like, receives a multimedia stream from a broadcaster 302. The primary media reception device outputs an output signal 304. The output signal is sampled by a sampler 306. For example, a microphone may be used to sample an audio clip of the media.

Optionally, the output signal may be processed 308, possibly using fingerprinting 310 and indexing 312, to generate clip data. The output signal may be processed by a processor associated with the sampler, such as a processor of a mobile telephone, tablet or other media reception device. Alternatively or additionally, the signal may be processed, at least in part, by the media synchronization manager. It is noted, however, that the size of the clip data file transmitted may be significantly reduced by processing the output signal before transmitting clip data to the media synchronization. Size of transmitted files may be a particularly important factor in applications where transmission speed is limited.

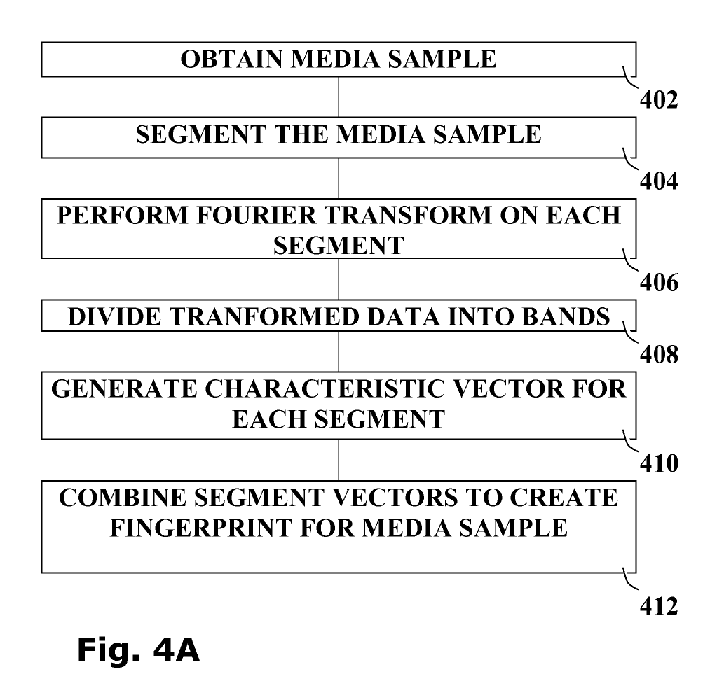

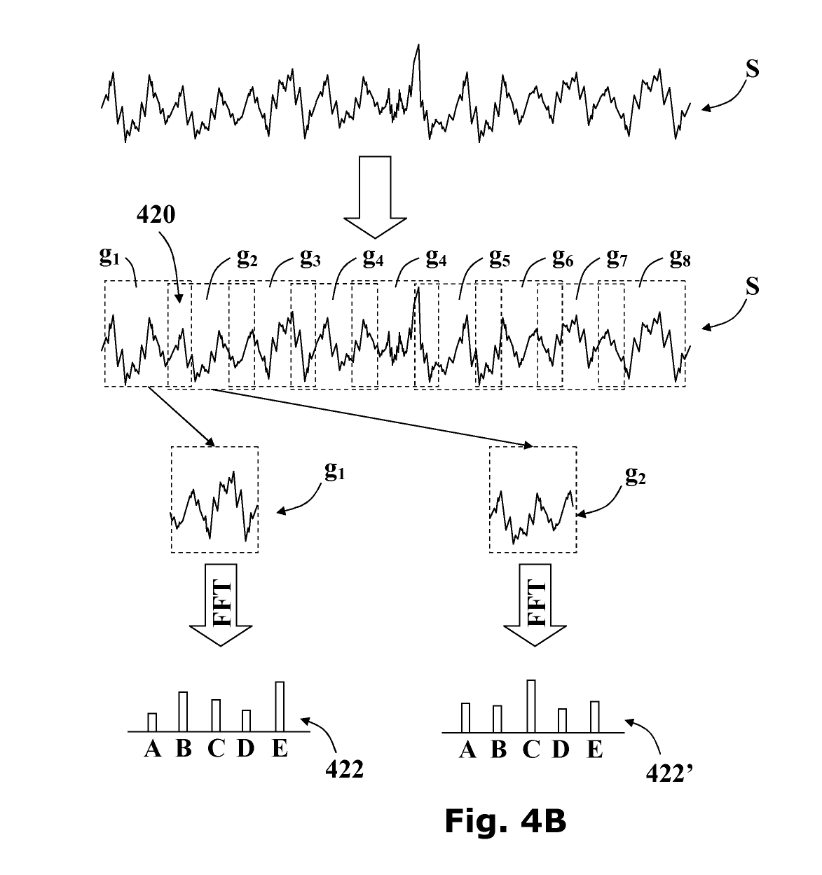

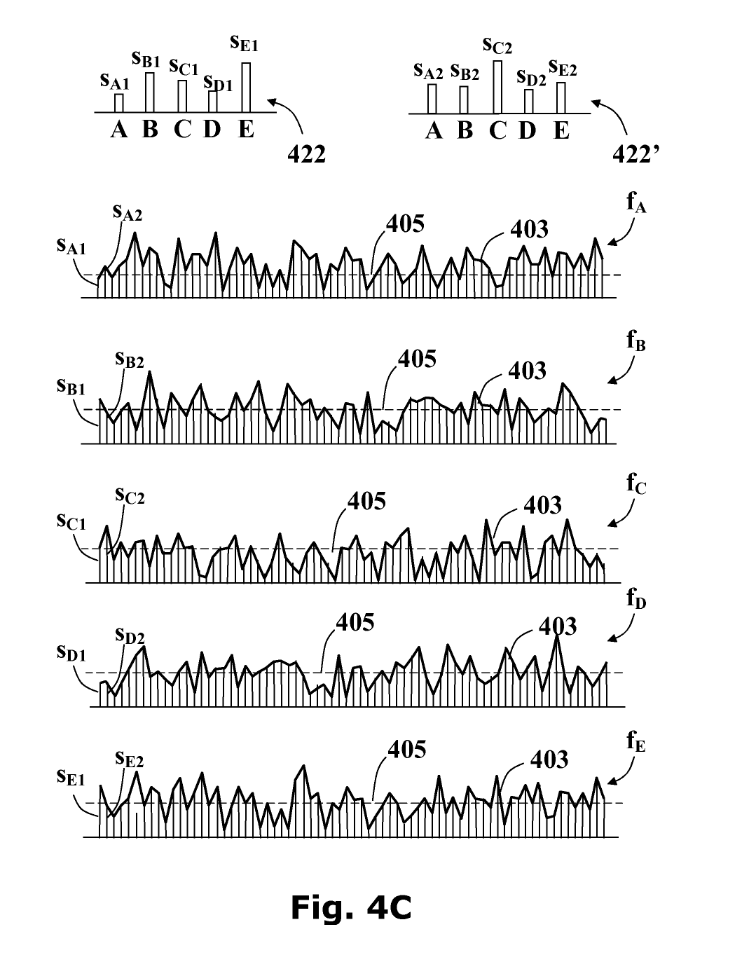

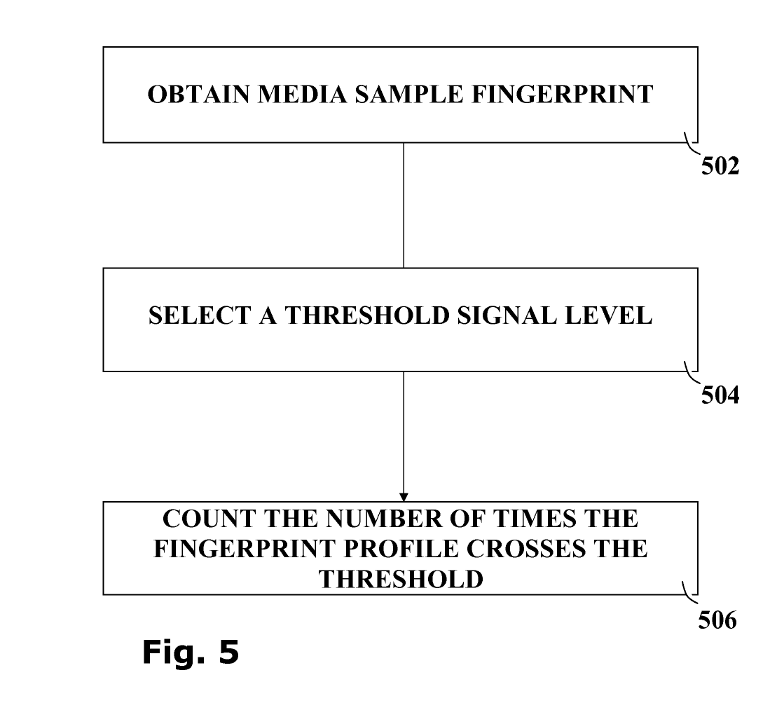

One possible method for fingerprinting multimedia data is described hereinbelow in relation to the flowchart of FIG. 4A, although other fingerprinting methods will occur to those skilled in the art. A possible method for indexing the multimedia data is described hereinbelow in relation to the flowchart of FIG. 5, although other indexing or hashing methods will occur to those skilled in the art. It is noted that such methods may be run on a processor associated with the secondary media reception device, the media synchronization agent or any other processor.

The clip data is transmitted to the media synchronization manager 314, where it is matched to the multimedia stream from which it was sampled. Optionally additional instructions, such as requests for particular content types, may be additionally transmitted to the media synchronization manager 316. A secondary media reception device may also receive synchronized content from the media synchronization manager 318.

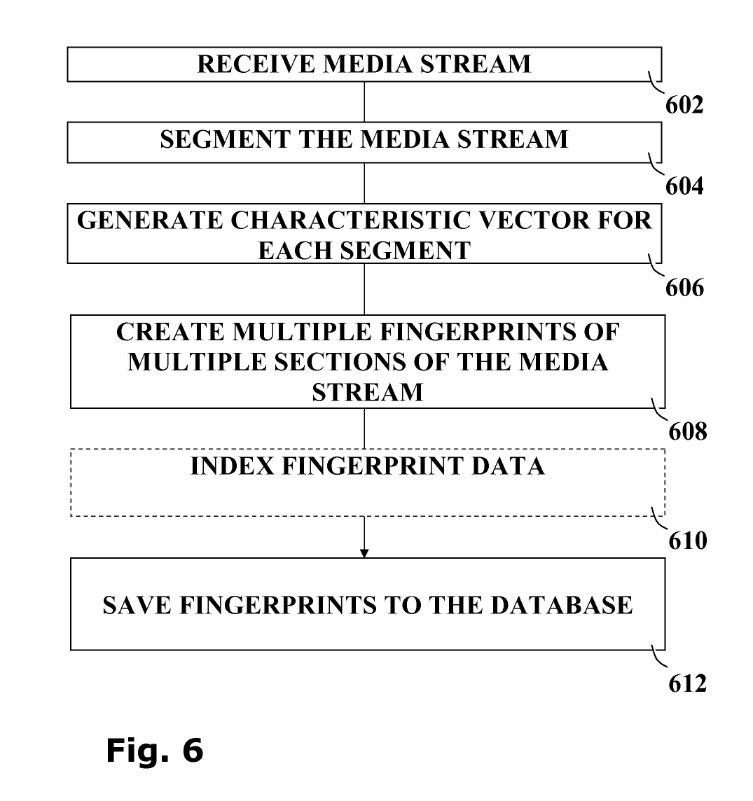

With particular reference to FIG. 3B, the media synchronization manager receives multimedia streams from at least one broadcaster 320. The multimedia streams are processed 322 and stored in a database 324. A possible method for populating the database of the media synchronization manager is described hereinbelow in relation to the flowchart of FIG. 6, although other methods of populating the database will occur to those skilled in the art.

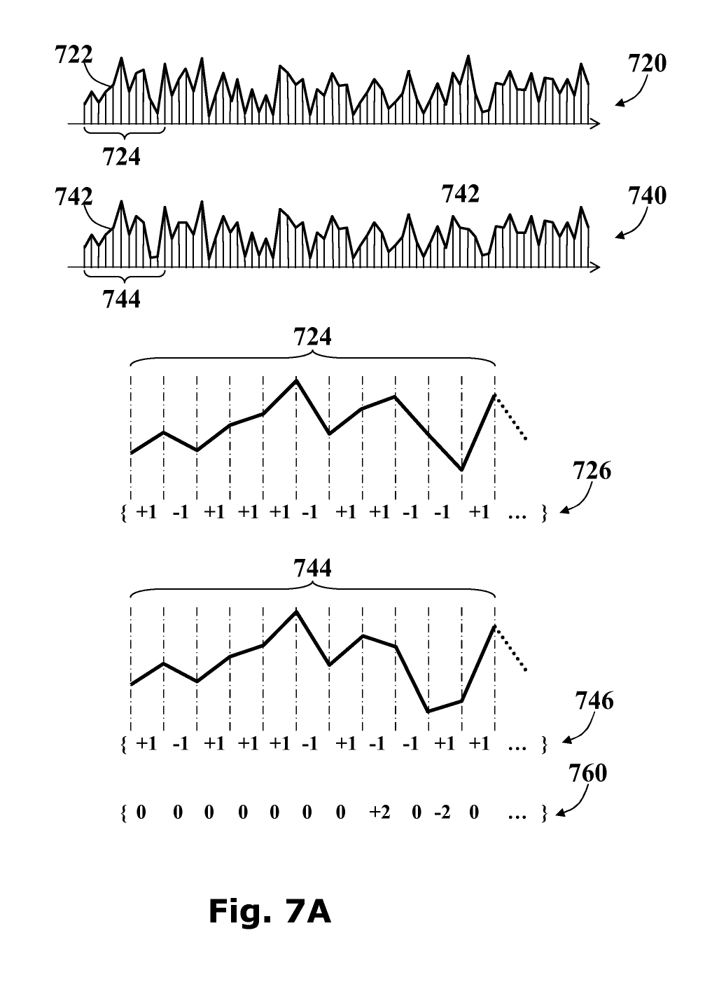

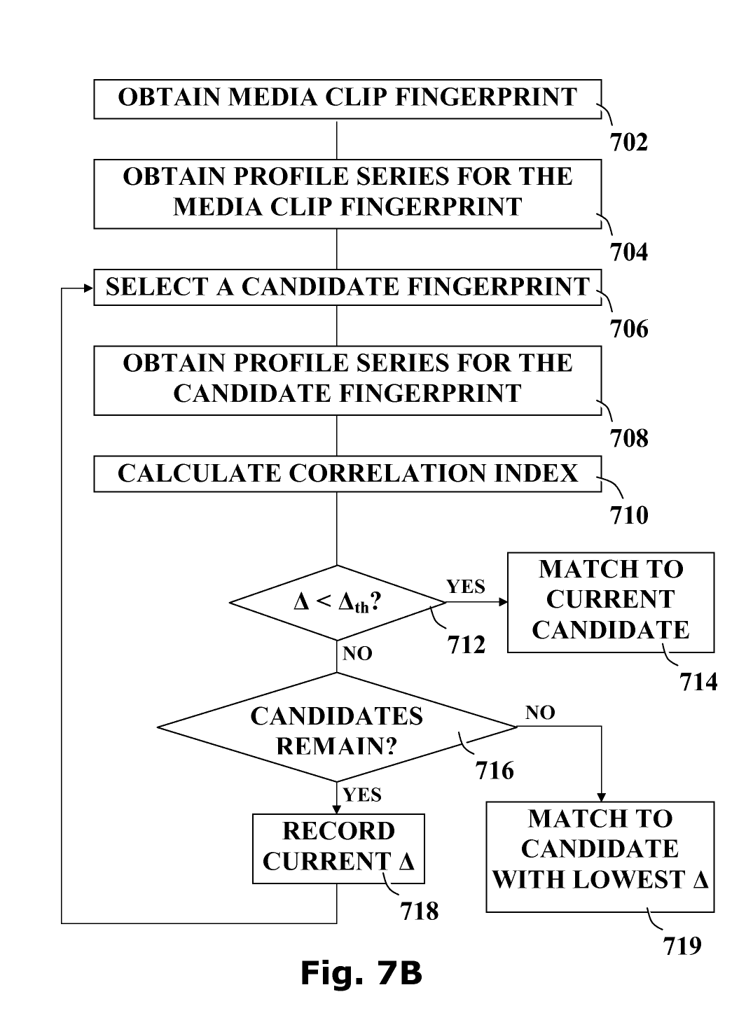

Clip data, transmitted by the sampling device, is received by the media synchronization manager 326. The media synchronization manager compares received clip data with data stored in its database in order to match the sampled clip data the data stream, and the point in that data stream, from which it was sampled 328. A possible method is described hereinbelow in relation to the flowchart of FIG. 7B for comparing and matching clip data to data stored in the database, other methods for matching clip data samples will occur to those skilled in the art.

Based upon the identity of the clip data as well as other user instructions, the media synchronization manager may further select content to distribute 330 and deliver the content 332 as required.

### Fingerprinting Media Samples

A fingerprinting algorithm may be used for uniquely identifying media samples. The media sample fingerprint may be useful, as noted hereinabove, as a way to limit the size of a clip data file for transmission from a sampling device to a media synchronization manager. Furthermore, as indicated hereinbelow, the media sample fingerprint may be readily hashed and used for comparing the sample with other media samples.

Reference is now made to the flowchart of FIG. 4A and the associated graphical representations of FIGS. 4B and 4C. A fingerprint F of a media sample S, such as an audio clip for example, may be generated as outlined below.

A media sample S may be obtained 402, for example by recording a short audio clip using a microphone, sampling a media stream, imaging a frame of video, or by some other sampling method. The media sample S is segmented into a series of smaller media segments gₙ 404. For example, the sample S may be segmented into a plurality of segments gₙ each having a manageable file size of 4 kilobits or so.

Segmentation may be executed, for example, by applying a window function, such as Hamming window or the like, to the sample S. Where appropriate, consecutive segments gₙ, gₙ₊₁, may overlap to a small degree say by 512 bits or so. The overlapping sections 420 may ensure that there are no information gaps produced by the data conversion process.

A fast fourier transform (FFT) may be applied to each segment gₙ 406, thereby providing a frequency spectrum characteristic of the segment. This frequency spectrum may be divided into a plurality of distinct bands bounded by maximum and minimum limits 408.

According to one embodiment, presented for illustrative purposes only, a frequency range of between say 300 hertz to 3400 hertz may be subdivided into five frequency bands, for example as follows:
Band A—from 300 hertz to 920 hertz,
Band B—from 920 hertz to 1540 hertz,
Band C—from 1540 hertz to 2160 hertz,
Band D—from 2160 hertz to 2780 hertz,
Band E—from 2780 hertz to 3400 hertz,

It will be appreciated that other frequency ranges and frequency bands may be used according to requirements. In some embodiments, a wider frequency range may be subdivided logarithmically. For example the frequency range of human hearing may be covered by a set of frequency bands divided logarithmically as follows: 16 hertz to 32 hertz, 32 hertz to 512 hertz, 512 hertz to 2048 hertz, from 2048 hertz to 8192 hertz, and from 8192 hertz to 16384 hertz. Still other frequency bands and ranges will occur to practitioners of the art.

The signal level for each frequency band may be calculated providing a characteristic vector Vₙ for each segment 410. Signal levels may indicate the energy of each band, the intensity of each band or another measurable parameter as will occur to the skilled practitioner. The characteristic segment vector Vₙ for each segment contains signal levels for each frequency band. In the example of a audio sample example given above, the characteristic segment vector Vₙ may be expressed as a histogram 422, 422′ or alternatively algebraically as:

Vₙ={S_{An},S_{Bn},S_{Cn},S_{Dn},S_{En}}

where s_{An} represents the signal level of the A band of the n^{th} segment gₙ.

A fingerprint for the overall media sample S may be created 412, for example by combining multiple segment vectors Vₙ.

Referring now to FIG. 4C, according to a particular fingerprinting algorithm, the sample fingerprint may be represented graphically as a set of five series f_{A-E}. The series are constructed for each band by taking the signal level for that band for each segment and arraying these values sequentially. Each series f_{A-E} therefore corresponds to one frequency band and contains the sequence of band signal levels for each segment. It is noted that the profile 403 of these series may be used to graphically illustrate the fingerprint.

Alternatively, the fingerprint may be represented algebraically by combining the segment vectors Vₙ sequentially into a characteristic matrix F. The characteristic matrix for the five band system of the example may be represented as:

$$F = ( \begin{matrix}{s}_{A 1} & {s}_{A 2} & ⋯ \\ {s}_{B 1} & {s}_{B 2} & ⋯ \\ {s}_{C 1} & {s}_{C 2} & ⋯ \\ {s}_{D 1} & {s}_{D 2} & ⋯ \\ {s}_{E 1} & {s}_{E 2} & ⋯\end{matrix} )$$

The fingerprinting method described above represents a possible method for uniquely identifying a media sample which may be used for the purposes of matching media signals. As required, other methods of uniquely identifying a sample may be used to provide a reference with which to compare data in media matching systems and the like.

### Indexing

It is a feature of some embodiments of the multimedia synchronization system described herein that they may be able to match media clips to streamed media in real time. Accordingly, sample fingerprints may be conveniently indexed for rapid search and retrieval. Referring back to FIG. 1, indexing may be undertaken at various points of the synchronization system 100, for example by a processor associated with a data sampler 142, by the comparator 166, the data extractor 162 or by other units as required.

One possible indexing method is represented in the flowchart of FIG. 5. A hashing algorithm is presented in which an index value is assigned to a media sample. The index may not uniquely identify the sample in the way that the fingerprint does, however, it may be used to reduce the set of samples which may be searched using a full comparison algorithm such as described below.

At least one sample fingerprint is obtained for indexing 502, optionally a plurality of fingerprints may be grouped together for the purposes of indexing. So for example, the fingerprints associated with a media selection of a particular duration, a two second section of video, say, may be indexed jointly.

A threshold signal level is selected 504. Referring back to FIG. 4C, the threshold signal level 405 is generally fixed at a level between the minimum expected signal level of any sample and the maximum signal level of any sample. According to requirements, a common fixed threshold level may be the shared by all frequency bands, alternatively, individual threshold levels may be defined for each frequency band. Alternatively, again, a flexible threshold may be defined in terms of the actual signal levels of a given sample, for example by taking the mid-level between the highest and lowest signals of the sample.

The number of times the fingerprint profile 403 crosses the threshold 405 is counted 506. This count may serve as an index for the fingerprint or set of fingerprints. Where required the method may count the number of times the profiles for all frequency bands cross the threshold. Alternatively, it may be sufficient for indexing purposes to count only a selection of the frequency bands.

Accordingly, each fingerprint, or set of fingerprints, may be associated with an index value. The index value provides an effective way for the comparator 166 to limit the number of candidate data sections to compare with a sampled clip as described hereinbelow. This is of particular importance in real time comparisons, where speed of processing is crucial.

### Populating Database

According to various embodiments, the media synchronization manager may be operable to match clip data relating to a sampled media clip with candidate media data stored in a database. In order to provide real time media synchronization of live media streams, it will be appreciated that it may be necessary to populate the database with media data in an ongoing fashion.

Referring now to the flowchart of FIG. 6, one method for populating the database with media data samples is described. This method may be executed by a processor associated with the media synchronization manager, for example a data extraction processor of a data matching server or the like.

At least one media stream is received 602, the media stream may be for example a video data stream broadcast by a television station, a live webcast or the like, alternatively the media stream may be pure audio data such as radio broadcast still other media streams may also be received, processed and stored in the database, as required.

The received media stream is segmented into a series of smaller media segments 604. The size of the segments may be determined such that the data file is readily processed and may depend on the strength and speed of the media extraction processor. For example a file size of 4 kilobits or so may allow the segments to be duly processed in real time.

As described hereinabove in relation to the fingerprinting algorithm outlined in FIG. 4A, segmentation may be executed, for example, by applying a window function, such as Hamming window or the like, to the media stream. Where appropriate, consecutive segments sₙ, sₙ₊₁ may overlap to a small degree say by 512 bits or so. The overlapping sections may ensure that there are no information gaps produced by the data conversion process.

A characteristic vector may be obtained for each segment of the media stream 606. The characteristic vector may be obtained, for example in a manner similar to that described above in relation to the fingerprinting algorithm. A fast fourier transform (FFT) may be applied to each segment, thereby providing a frequency spectrum characteristic of the segment. This frequency spectrums may be divided into distinct bands bounded by maximum and minimum limits and the signal levels for each frequency band may be calculated providing a set of values characteristic of the media segment.

Characteristic vectors of multiple media segments may be grouped sequentially to create fingerprints of multiple sections of the media stream 608. The media sections may be selected according to considerations such as file size, duration and the like and may overlap such that the database may be populated with sufficient candidate media sections to allow high probability of a match with clip data received from a sampling device.

In a particular example, each characteristic vector may be grouped with all the characteristic vectors relating to the subsequent two seconds of the media stream to provide fingerprints for all two second sections of the media stream. Such fingerprints may serve as candidate media data for comparison with clip data according to a comparison algorithm such as described hereinbelow.

Optionally, the candidate fingerprint data may be indexed 610. For example, an indexing method such as described hereinabove in relation to the flowchart of FIG. 5 may be performed on each fingerprint. Thus, the number of times the profile of each fingerprint crosses a threshold signal level may be used as a possible index to reduce the set of samples which may be searched using a full comparison algorithm such as described below.

The fingerprints for each media section may be saved to the database along with their associated indices and time stamps 612. Thus the database may be populated with readily searched and matched media data.

### Fingerprint Matching

Reference is now made to FIG. 7A which graphically represents how two media clip fingerprints 720, 740 may be compared. A first media clip fingerprint 720 may be obtained, for example by fingerprinting a sampled media clip using an algorithm such as described in relation to FIG. 4A. A second media clip fingerprint 740 may be obtained, for example by selecting a candidate fingerprint from a database of stored media clips.

Each media clip fingerprint 720, 740 consists of a sequence of signal levels sₙ, σₙ for frequency bands such as described hereinabove. The profile 722, 742 of each fingerprint 720, 740 therefore consists of a series of line sections joining adjacent signal levels. A section 724, 744 of each fingerprint profile is represented in greater detail for the sake of clarity of explanation. For the sake of clarity only a single frequency band is used below to illustrate the matching process, it will be appreciated that the method may be readily extended to multiple frequency bands as required.

It is noted that each fingerprint profile 722, 744 may be characterized by a profile series 726, 746 comprising the first derivative signum values for each line section of the profile. The first derivative signum value depends upon the slope of the line section, thus where a signal level is higher than the previous signal level in the sequence, the signum value for the line section between them is +1, where a signal level is lower than the previous signal level in the sequence, the signum value for the line section between them is −1. Where two adjacent signal levels are equal, the signum value for the line section between them is 0. This may be expressed algebraically as:

$$sgn ( {s}_{( n + 1 )} - {s}_{n} ) = \{ \begin{matrix}- 1 for {s}_{( n + 1 )} < {s}_{n} \\ 0 for {s}_{( n + 1 )} = {s}_{n} \\ + 1 for {s}_{( n + 1 )} > {s}_{n}\end{matrix}$$

The profile series 726, 746 for the two fingerprints 720, 740 may be compared by reference to a delta series 740 comprising the differences between corresponding members of the profile series 726, 746. It will be appreciated that the delta series typically comprises values of 0, +2 and −2. Thus the n^{th} member of the delta series may expressed algebraically as:

[sgn(s₍ₙ₊₁₎−sₙ)−sgn(σ₍ₙ₊₁₎−σₙ)]

A useful numerical indication for the similarity between the two fingerprints may be found by summing the squares of the members of the delta series. A correlation index Δ may be expressed algebraically as:

$$Δ = {\sum }_{1}^{N} \{ {[ sgn ( {s}_{( n + 1 )} - {s}_{n} ) - sgn ( {σ}_{( n + 1 )} - {σ}_{n} ) ]}^{2} \}$$

It will be appreciated that the closer the correlation index Δ is to zero, the greater the degree of similarity between the two fingerprint. Accordingly, a threshold correlation value Δₜₕ may be defined below which the two fingerprints may be considered to be identical.

Reference is now made to the flowchart of FIG. 7B which shows the main steps of a possible method for matching a fingerprint of a sampled media clip to a fingerprint of a media clip selected from a database. It will be appreciated that other methods may be used in various versions of the overall method described hereinabove in relation to FIG. 3A. The method may be executed, for example, by a processor associated with a media synchronization manager, a comparator processor of a data matching server, a processor of a remote device such as a mobile telephone in communication with a database or the like.

A media clip fingerprint is obtained 702. According to various embodiments, clip data fingerprint may be received from a media sampling device in communication with a data matching mechanism. For example a secondary media reception device, telephone or the like, may sample media output by a primary media reception device and transfer a clip data fingerprint to a comparator. Alternatively, raw media data may be sent to a data matching mechanism and finger printed, for example using an algorithm such as described in relation to FIG. 4A.

A profile series may be generated for the received clip data fingerprint 704. The profile series may be calculated, for example, by arraying the signum values of all line sections in the clip data fingerprint as described hereinabove, although other methods for calculating a profile series may be considered. Generation of a the profile series may be executed by a processor associated with a comparator, alternatively, a sampling device, such as a mobile telephone, computer or tablet device connected, may calculate the profile series and send it as clip data, possibly via an internet link, to a data matching mechanism.

A first candidate media clip fingerprint may be selected 706, possibly from a database associated with a data matching mechanism. The database may be populated with candidate media clip fingerprints using a method such as described hereinabove. Alternatively, the database may store raw media data which may be fingerprinted by a comparator before analysis.

Optionally, in order to increase the speed of the selection process, candidate media clip fingerprints may be selected from a targeted subset of all the media clips stored in the database. The targeted subset of candidate media clips may be weighted favorably according to a number of factors. For example an index, such as produced by the hashing algorithm described hereinabove in relation to FIG. 5, may be used to weight candidate media clips. Thus, the threshold count indices of stored media clips may be compared with the threshold count index of the sampled media clip. Accordingly, clips having a threshold count index close to that of the sampled media clip may be selected preferentially from the database and included in a targeted subset of candidate media clips.

Another weighting factor may be a time stamp indicating the time at which a sample was collected. If the time is known at which the sample being matched was collected, the comparator may select candidate media clips corresponding to sections of the media stream broadcast at or around the time that the sample was collected. Thus, clips broadcast close to the sampling time may be assigned a greater weighting than those broadcast further from the broadcasting time.

Still other weighting factors may take into consideration user specific information such as a user's preferences, previously sampled clips, user profile, age, sex, geographical location, and so on. Further weighting factors, for use in embodiments of the system disclosed herein, will occur to the skilled practitioner.

A profile series may be generated for the selected candidate media clip fingerprint 708. A correlation index Δ may be calculated comparing the received candidate media clip fingerprint and the selected candidate media clip fingerprint 710. As outlined above, such a correlation index may be calculated by summing the squares of all the members of a delta series comprising the differences between corresponding members of the two profile series being compared. Other methods for generating a correlation index may be alternatively used where appropriate.

The correlation index Δ is compared to a threshold level Δₜₕ 712. If the correlation index Δ is below a threshold value Δₜₕ then the received media clip is matched to the current candidate media clip 714.

If the correlation index Δ is not below the threshold level Δₜₕ then the number of remaining candidate media clip is checked 716. If more candidate media clip remain, then the current correlation index is recorded 718 and a new candidate media clip fingerprint is obtained 706. If no more candidate media clips remain then the received media clip is matched to the candidate media clip having the lowest correlation index Δ 719.

Still other methods for matching the received media clip to clips stored in the database may alternatively be used in various media synchronization systems as suit requirements.

Thus in the above, various systems and methods are disclosed for matching media clips. It is noted that such systems and methods provide real time matching of clip data pertaining to sampled media output and data extracted from media streams. Thereby, the systems may enable synchronization between delivered content and broadcast media streams.

The scope of the disclosed subject matter is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

What is claimed is:

1. A media matching system for delivering at least one content stream to at least one media receiving device, said content stream being at least partly synchronized to at least one media stream received by a primary media receiving device, wherein said system comprises at least one of:
a data matching mechanism; and
a media sampler,
wherein said data matching mechanism comprises
at least one database for storing a plurality of candidate media clip fingerprints pertaining to said at least one media stream,
at least one comparator, configured to match at least one candidate media clip fingerprint to a fingerprint of clip data pertaining to a sampled clip of an output signal from said primary media receiving device, and
at least one content selector, configured to send said content stream to at least one address, and
wherein said media sampler is configured to
collect a sample of the output signal from said primary media receiving device, and
send clip data pertaining to said sample of the output signal to said comparator.

2. The system of claim 1 wherein said data matching mechanism further comprises a data extractor in communication with said database, wherein said data extractor is configured to:
receive media data from at least one media stream,
process said media stream to generate said candidate media clip fingerprints, and
save said candidate media clip fingerprints in said database.

3. The system of claim 1 wherein said sampler is associated with a secondary media receiving device configured to receive said content stream.

4. The system of claim 3 wherein said secondary media receiving device is selected from at least one of a group consisting of: mobile telephones, tablet computers, games consoles, computers, television sets.

5. A method for delivering at least one content stream to at least one media receiving device, said content stream being at least partly synchronized to at least one media stream received by a primary media receiving device, said method comprising the steps:
receiving at least one said media stream;
processing said at least one media stream to generate a plurality of candidate media clip fingerprints;
saving said candidate media clip fingerprints to a database;
receiving clip data pertaining to a media signal;
obtaining a fingerprint of said media signal;
comparing the fingerprint of said media signal with at least one candidate media clip fingerprint;
matching said media signal to at least one candidate media clip; and
sending said content to at least one address.

6. The method of claim 5 further comprising the steps:
sampling an output media signal from said primary media receiving device;
processing said media signal to generate said clip data; and
sending said clip data to said data matching mechanism.

7. The method of claim 6 wherein the step of processing said media signal comprises
fingerprinting said media signal, and
indexing said media signal.

8. The method of claim 5 wherein the step of obtaining a fingerprint comprises:
segmenting a media sample into a plurality of segments;
generating a characteristic vector for each segment of said media sample by:
performing a fourier transform on each segment of said media sample;
dividing the transform into a plurality of frequency bands; and
arraying the signal levels for all frequency bands; and
combining said characteristic vectors of each segment of the media sample.

9. The method of claim 5 further comprising a step of indexing said fingerprints.

10. The method of claim 9 wherein said fingerprints comprise an array of signal levels and said indexing comprises:
generating a profile of said fingerprint;
selecting a threshold signal level, and
counting the number of times said profile crosses said threshold.

11. The method of claim 5 wherein the step of comparing the fingerprint of said media signal with at least one candidate media clip fingerprints comprises calculating a correlation index Δ between a first series of N values sₙ, pertaining to the fingerprint of said media signal, and a second series of N values σₙ, pertaining to the candidate media clip fingerprints, wherein said correlation index is calculated by the formula
$$Δ = {\sum }_{1}^{N} \{ {[ sgn ( {s}_{( n + 1 )} - {s}_{n} ) - sgn ( {σ}_{( n + 1 )} - {σ}_{n} ) ]}^{2} \}$$

12. The method of claim 11 further matching said media signal to at least one said candidate media clip fingerprint by:
selecting at least one candidate media clip fingerprint;
calculating a correlation index Δ for each candidate media clip;
comparing the correlation index Δ to a threshold value Δₜₕ for each candidate media clip; and
selecting a candidate media clip fingerprint having a correlation index Δ below said threshold level Δₜₕ.

13. The method of claim 11 further matching said media signal to at least one said candidate media clip fingerprint by:
comparing said media signal to all of at least a subset of candidate signals; and
selecting the candidate media clip fingerprint with the lowest correlation index Δ.

14. The method of claim 5 wherein said candidate media clip is selected from a subset containing candidate media clips extracted from said media stream in a given time period.

15. The method of claim 5 wherein said candidate media clip is selected from a subset of candidate media clip fingerprints stored in said database.

16. The method of claim 15 wherein said subset comprises candidate media clip fingerprints having an index value close to that of the media signal fingerprint.

17. The method of claim 15 wherein said subset comprises candidate media clip fingerprints extracted from the media stream during a determined time period.

18. A method for delivering at least one content stream to at least one media receiving device, said content stream being at least partly synchronized to at least one media stream received by a primary media receiving device, said method comprising the steps:
sampling an output media signal from said primary media receiving device;
processing said media signal to generate clip data;
sending said clip data to a comparator operable to compare said clip data to media data extracted from said media stream and stored in a database; and
receiving said content stream from a content selector, said selector operable to select content at least partially synchronized to said media stream.

19. The method of claim 18 wherein the step of processing said media signal to generate clip data comprises fingerprinting said media signal.

20. The method of claim 19 wherein fingerprinting said media signal comprises:
segmenting a media sample into a plurality of segments;
generating a characteristic vector for each segment of said media sample by:
performing a fourier transform on each segment of said media sample;
dividing the transform into a plurality of frequency bands; and
arraying the signal levels for all frequency bands; and
combining said characteristic vectors of each segment of the media sample.
